(19) United States
(12) Patent Application Publication
(10) Pub. No.: US 2017/0323350 A1
(43) Pub. Date: Nov. 9, 2017

(54) CLOUD-BASED WORKFLOW MANAGEMENT PLATFORM DEFINED BY PERMISSION-BASED ROLES AND RELATIONSHIPS FOR ADMINISTERING, CREATING, AND PROCESSING COMMERCIAL ADVERTISING WORK ORDERS

(71) Applicants: Tonya Laderer, Babson Park, FL (US); John Laderer, Babson Park, FL (US)

(72) Inventors: Tonya Laderer, Babson Park, FL (US); John Laderer, Babson Park, FL (US)

(21) Appl. No.: 15/604,056

(22) Filed: May 24, 2017

Related U.S. Application Data
(63) Continuation of application No. 14/606,418, filed on Jan. 27, 2015.
Application No. 14/606,418 is a continuation-in-part of application No. 13/679,279, filed on Nov. 16, 2012, now abandoned.
(60) Provisional application No. 61/561,008, filed on Nov. 17, 2011.

(51) Int. Cl. G06Q 30/02; G06Q 10/06

(52) U.S. Cl. CPC G06Q 30/0276; G06Q 10/063118

(57) ABSTRACT

An internet-based workflow management platform for use in the broadcast and web industry to facilitate resources sharing and improved production efficiency—specifically adapted for creation and production of commercial advertisements. An internet, cloud-backed system for the creation and production of commercial advertising spots is provided wherein a role-based structure ensures that users only see the information relevant to them and relevant to their part in the overall process and workflow that ends with the completion of a work order. The internet and cloud structure of the platform affords vastly improved communication and information access to enable persons working on creative production or commercial advertisements through said work order to be geographically situated anywhere, as opposed to the limits of one physical location.

### CROSS-REFERENCE TO RELATED APPLICATIONS

This application is a continuation-in-part of U.S. patent application Ser. No. 13/679,279, filed on Nov. 16, 2012, which claims the benefit of provisional U.S. Patent Application Ser. No. 61/561,008, filed on Nov. 17, 2011.

### STATEMENT REGARDING FEDERALLY-SPONSORED RESEARCH OR DEVELOPMENT

Not applicable.

### REFERENCE TO A SEQUENCE LISTING, A TABLE, OR A COMPUTER PROGRAM, LISTING COMPACT DISC APPENDIX

Not applicable.

### BACKGROUND OF THE INVENTION

### 1. Field of the Invention

The present invention relates generally to the technical field of internet-based software pursuant to workflow management; and, more particularly, to an internet-based work order, resource, and creative management application . . . as well as supervision of the aforementioned by supervisory individuals or corporate functionaries.

### 2. Description of Related/Prior Art

Commercial advertising is a form of communication used to inform and persuade an audience—such as viewers, readers, or listeners—to take action with respect to goods, services, or brands. Advertisements, irrespective of medium or intended consumer audiences, are usually paid for by sponsors or businesses, created by artistic media professionals, and presented to the consumers through traditional or emerging media outlets and formats. These outlets include radio and television broadcasts, newspaper and internet advertisements, online publications, digital audio and video transmissions, phone and tablet devices, video games, etc. During the fiscal year 2010, commercial advertising expenditures in the United States totaled approximately $300 billion. Meta-analysis done by well-established, specialist firms consistently shows advertisement expenditures and revenue to be increasing.

The creation and production of commercial advertising work orders, commonly referred to as “spots”, traditionally involves a paper-laden workflow process wherein a wide variety of paperwork forms are completed by hand, then submitted as a paper copy as it passes through various stages of the sales, promotion, creative, and production processes. Though the exact workflow is interdependent between the precise medium (radio, television, internet, etc.) and the parties or companies involved in the workflow, the same basic structure of information-sharing, delegation, and work exists.

A production workflow process that is paperwork-dependent (and which is strictly dependent upon these paper copies of work orders to pass through the workflow efficiently and correctly) has numerous shortcomings. To wit: at any given point in a paper-based workflow system, not every person involved in the workflow has access to the advertising work-order, much less in an up-to-date manner. The day-to-day implications of the paper-based workflow is one of inefficiency. That is, the creative talent responsible for fulfilling the advertising work order as instructed, are overwhelmingly the last to receive the paper order so that he or she may begin work.

This introduces further complications when completed advertisements must be approved by the buyer or advertiser, since the final advertisement may not be completed before the conclusion of a business day—a direct result of the delays, complications, and inefficiencies inherent to a linear, paper-based workflow.

Further, the originator of the advertising work order must directly contact others in the workflow physically, by phone, or by email to request updates. Similarly, the producer of the advertisement must act in a reciprocal manner to understand the status of his workload and creative demands (in the form of a paper work order) that he may not have in his possession at that time.

The described contact process is disorganized, prone to error and misunderstanding, and slowed.

Completed work orders on paper are typically filed in physical paper storage, which is time and space consuming, difficult to organize, and cumbersome to audit or search at a later date. Not only does this process unnecessarily expend human work hours but also physical space in the form of usable office space. Even employing the method emailing of work orders still relies heavily on manual sorting and organization. Whether electronic, paper-based, or a hybridization of both, the many steps and persons involved directly increases the potential for human error (missing a submission deadline/cutoff, forgetfulness to pass work orders on to the next step in a workflow, relevant emails being marked as spam—thereby going unnoticed, or simply misplacing a paper copy of a work order).

What's more, communication and reference materials involved in a work order get spread out and are not directly connected, accessible, nor accounted for at all times.

Finally, the multiple parts at the end of a workflow are often stored in one central location to which not all involved parties have access, whether by inconvenience, policy, or regulatory restrictions. This complicates matters when there are questions about a completed or past work order—or simply the need to locate a past work order to submit a similar one at the beginning of the workflow.

Recently, improvements in computer and network technology have resulted in computer- and network-assisted workflow management. For example, U.S. Pat. No. 7,680,676, as issued to Schell et al., discloses a method for producing a programming element for a broadcast radio or television station which entails generating an order in a database to produce a recorded announcement and identifying the script (written words for an advertisement or commercial) for the work order. The script and work order are stored at a first location in the database by a salesman (an intermediate between the client/entity buying the advertisement and the medium where it will be broadcast or displayed). The method continues by recalling said work order from the database by a traffic and/or continuity director, who—in turn—assigns a unique identification number to the advertisement(s), scheduling the work order for broadcast, then storing the script and identification number at a second location in the database. The stored script, work order, and identification information are recalled from the second location by the producer, who is responsible for executing the technical and creative demands of the work order. The producer does this by locating the elements required in the script, following any unique or specific demands or notes from the advertiser or salesman, then assembling a final product using creative skill and specialized audio or video software. At this point in a traditional workflow, the final advertisement or recorded announcement is, in turn, stored in a third location alongside the work order in the database. The method ends by retrieving the stored announcement for use by the broadcast station(s).

U.S. Pat. No. 7,840,930, issued to Sayal et al., discloses a method and system for integrating workflow management systems with the business-to-business interactions between workflow designers and business partners. In other words, it ostensibly intends to bridge the gap between workflow, business, and creative execution. The system therefore contemplates design tools that enable workflow templates, which correspond to different interaction and communication standards to be generated with minimal, manual effort by the workflow designer.

The workflow design tools enable a business to communicate with other business partners or entities, who may comply with different or more complicated business-to-business interaction standards. For example, the design tools enable a request for rate quotes from multiple business partners, who also comply with separate business interaction standards in the same overall workflow.

Published U.S. Patent Application US 2008/0052150, to Grouf et al., discloses methods and systems for generating a schedule and dollar value to a potential radio advertiser. This approach may include storing rate information of a plurality of radio media properties, storing information regarding the radio audience or demographics reached by the radio media properties, generating a media or advertising plan based on said rates, information regarding the advertiser(s) themselves, and presenting the media/advertising plan to the radio advertiser for potential purchase. The radio advertisement(s) may include a terrestrial broadcast commercial, and the media property may include a radio broadcaster.

Published U.S. Patent Application US 2005/0261955, to Humble et al., discloses a film production staff administration system for generating, collecting, storing, retrieving, and modifying data related to union-association information related to an individual used as creative talent. In many situations, this information is required by a union for broadcast productions that advantageously eliminates the inefficient and error-prone practices of the prior art, especially in relation to the use of paper-based forms that must be manually prepared, updated, revised, reviewed, and ultimately executed.

Published U.S. Patent Application US 2005/0075956, to Artis, discloses a method or system for facilitating the creation and promotion of creative works which involves the steps of displaying (or otherwise providing) information about one or more undeveloped creative works, then receiving and processing these requests for purchases of benefits relating to one or more of these undeveloped creative works.

Published U.S. Patent Application US 2003/0139955, to Kirii et al., discloses a task-support method which issues a task instruction to workers. This method also monitors the working state of each of the workers. It also includes an instructing step for sending the task instruction to at least one of the workers, a receiving step for receiving from any one of the workers a notification which reports the acceptance or initiation of a task specified by the task instruction, and reports the acceptance or initiation of the task.

Published U.S. Patent Application US 2002/0095228, to Corts et al., discloses a methodology and system for creating data, managing data, associating data with audio, scheduling audio for broadcast, and tracking production and sales information in regards to the data. Furthermore, these embodiments provide a methodology and system for identifying characteristics of the audio and data that trigger the transmission of data within a broadcast, as well as characteristics regarding the continuity or integrity of the data presentation, such as the timing during the broadcast.

While the advancements disclosed in the background art generally appear suitable for the specific applications to which they are directed, there exists a need in the art for an improved, internet-based work order and resource management/sharing system specifically adapted for submission, tracking, collaboration, centralization, archiving, and an overall non-linear workflow method to facilitate the creation and production of commercial advertising work orders.

### BRIEF SUMMARY OF THE INVENTION

The present invention overcomes the limitations and disadvantages present in the art by providing a role-based workflow management platform which is accessed via a global computer network, namely the internet. This centralized, non-linear method of interaction between invention and user is particularly well suited for use in the broadcast, print, digital, and web industries to facilitate and benefit resource sharing, improved accountability and collaboration, and production efficiency in the creation and production of commercial advertising and work orders. As used herein, the terms “commercial advertisement”, “spot”, “commercial”, or “commercial advertising” shall refer customarily to any form of an advertisement, promotion, or campaign of a production or service that is broadcast, transmitted, or embedded within or on any platform or medium. Additionally, industry-standard terms such as “announcement”, “transmission”, or “promotion” may generally be inferred to equate to the aforementioned.

Examples include, but are not limited to, audio commercials, video commercials, live announcements, recorded announcements, internet advertisements, print advertisements, text (SMS) advertisements, targeted email transmissions, etc.

In accordance with a preferred embodiment, an internet-based workflow management platform is provided wherein a role-based structure (where “role” represents the abilities assigned to a person or group of persons based on his or her duties within the workflow) ensures that a user sees only information relevant to his or her role or duties within the workflow.

The internet-based architecture of the platform provides dramatically improved, timelier communication, and access to up-to-date information. This platform therefore allows those involved in completing or advancing the progress of a work order to participate in or contribute to the workflow from any physical location, as opposed to being constrained to a specific physical presence in order to have direct access to a paper-based workflow.

Furthermore, because information is available immediately to each relevant participant further along the workflow, there is not only a dramatic reduction in the potential for communication problems or human error, but also an opportunity to deliver a finished work order expeditiously, without having to wait for the information to be passed to the end of the workflow (as would be the case in a paper-based workflow). What's more, because the information is accessible immediately by all concerned parties in the workflow, errors may be identified and eliminated much more briskly, and final products can be completed expediently.

These advantages overcome previous workflow models not only by saving and concerning time, but also by increasing accountability: preserving a record of every action associated with the work order. The platform centrally archives completed work orders upon completion, thus making recall by filter or search a fast, simple task. This is a radical departure from the shortcomings of a paper-based workflow as already outlined. Specifically, locating or recalling a completed work order in a paper-based workflow would require the location of the paperwork, searching through the records by hand (potentially having to cull many similar work orders in trying to find a specific one), and ultimately searching for a specific work order (if access to work orders is even permitted or feasible).

Accordingly, it is an object of the present invention to provide advancements relating to systems, workflow solutions, and asset/resource sharing directed toward the creation, production, and dependability of commercial advertising and its furtherance.

Another object of the present invention is to provide a centralized, internet-based (and therefore globally-accessible) workflow management platform wherein roles and relationships of users provide the basis for administering, creating, processing, archiving, filtering, and searching of work orders.

The present invention also allows users, groups of users, companies, or other entities to customize and tailor details of the workflow to suit their preferred method of processing work orders. In essence, moving from a paper-based workflow to the present invention permits the incorporation of techniques or policies that may be present in a given paper-based workflow, but implemented within the present invention in a more efficient manner.

For example, at various stages in the workflow process, approval from a role-based user may be required before the work order may advance inside the workflow and therefore be visible to other relevant parties. It is common practice for approval to be required on such criterion as a price for commercial advertisement, approval of a written script before the advertisement can be produced as a final product, or—perhaps most commonly—the approval by the advertiser of a final produced advertisement or work order before it is permitted to be broadcast.

The invention not only allows for these tiered approval processes to occur (and keep visibility of a work order confined to relevant users), but also provides—through the role-based user system—an intuitive and simple method for designation of which user(s) may approve specific requests or milestones (also based on role). The approval in the affirmative permits the work order to continue within the invention's workflow immediately, without the need for any manual communication or any paperwork whatsoever.

Similar to the previous object, the present invention also allows further customization by means of the work order itself within the workflow. This is manifested by the ability to add, remove, or modify custom fields within the work order. What's more, administrators of the workflow may designate certain portions of the work order as required or mandatory, meaning the work order cannot enter the workflow unless these fields are provided and are valid. The invention inherently extends options and granular control over the work order and, indeed, the workflow as a whole. In so doing, an overwhelming abundance of the shortcomings of traditional, paper-based workflows are overcome.

Yet another object of the present invention is to allow not only rapid communication, but also delegation. Since work orders typically require assignments based on roles (for example, the person or persons responsible for the creative production of a work order), the same role-based system is utilized to effect these delegations, which could also be thought of as assignments. Upon delegation/assignment, the delegator's action causes an immediate notification to the assignee of his or her responsibilities with respect to a specific work order. Since the invention allows for users, companies, and other entities to collaborate through role-based relationships, this not only means work on the assigned, role-based task may commence outright, but also that large companies may share and delegate resources in any way desired.

For example, a large broadcast company may create groups of users or roles based on geographic regions or corporate divisions. Since the invention permits these roles to be aggregated or grouped in any way desired, it also means the invention allows resources, communications, assets, and participation in the workflow and work orders to be shared/delegated/assigned without concern for geographic distribution of users.

In essence, this means that a diverse, vast set of users may be utilized at without hindrance to empower not only efficient, geographic-independent communication, collaboration, and delegation, but also the best possible role-based user may be tasked with his or her portion of the work order and/or workflow to produce the best possible final commercial advertisement in the least amount of time.

Considering the invention accelerates the processing of a work order and provides the opportunity to spur progress by all relevant users immediately, it also surmounts and supplants the intrinsic limitations of a paper-based workflow.

### BRIEF DESCRIPTION OF THE SEVERAL VIEWS OF THE DRAWING

Various other object, features, and attendant advantages of the present invention will become fully appreciated as the same becomes better understood when considered in conjunction with the accompanying drawings, in which reference characters designate the same or similar parts throughout the several views, and wherein:

FIG. 1 is a flow chart illustration of an internet-based workflow management platform in accordance with the present invention;

FIG. 2 depicts the screen/user view of the folder/inbox section in the present invention, displaying the platform's typical use for production workflow;

FIG. 3 depicts screen views for the points of contacts menu (delegation of assignments based on role) displayed both as active and inactive dispositions;

FIG. 4 depicts a screen view of a typical work order creation input screen that is to be interacted with and populated by the user;

FIG. 5 depicts a screen view for talent search and collaborative functions of the present invention;

FIG. 6 depicts a screen view of a history function specific to a work order of the present invention;

FIG. 7 depicts a screen view of a blog function (mass communication in the form of a conversation) specific to a work order (or group of work orders) of the present invention;

FIG. 8 depicts a screen view of a customer relationship management (CRM) logging and reference function of the present invention.

### DETAILED DESCRIPTION OF THE INVENTION

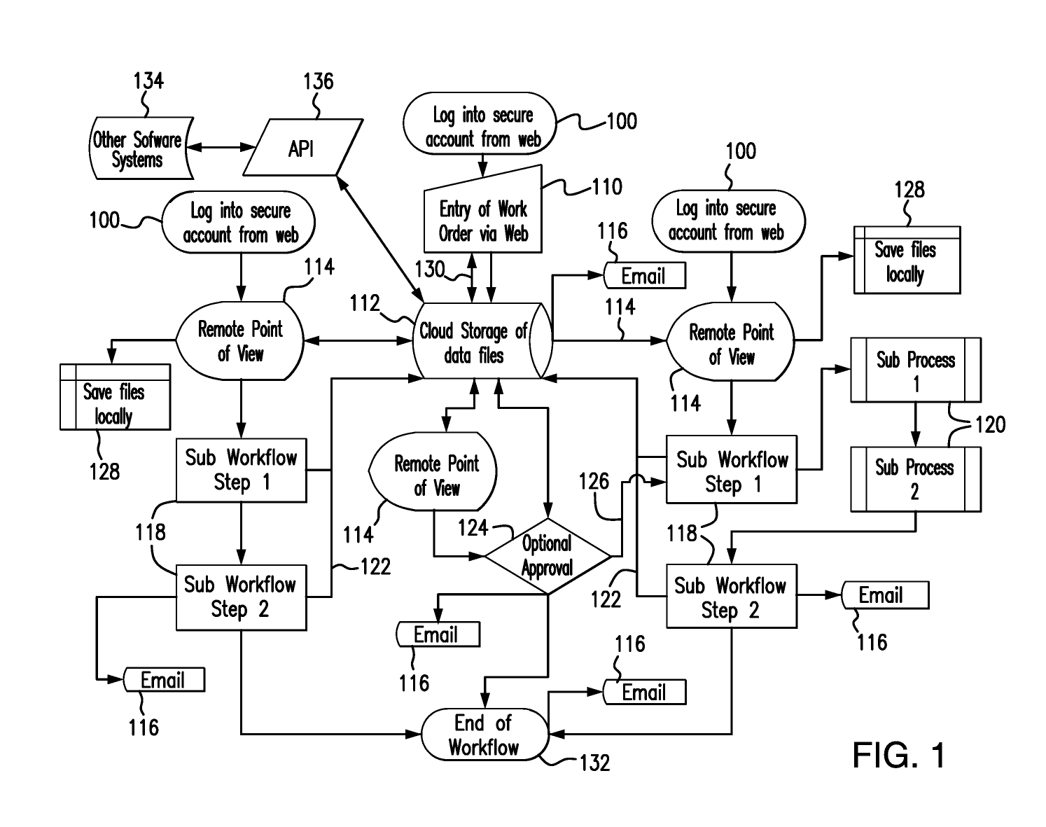

Turning now to the drawings, FIGS. 1 through 8 depict and illustrate a preferred embodiment of the internet-based workflow management platform wherein roles and relationships provide the foundation for administering, creating, and processing work orders in accordance with the present invention.

FIG. 1 provides a flowchart illustration of a typical workflow model (the start-to-finish process for completion of a work order). It is shown that the invention is accessed via web browser 100 where a work order is entered 110 and stored into cloud storage 112 so that it's accessible to other remote points of contacts (“POCs”), assignees, and role-based users 114 for whom the work order is relevant by means of visibility, editing, or deletion. POCs 114 receive email notifications 116 and can begin their specifically assigned tasks as part of a sub-workflow 118, which may also contain sub-processes 120, the results of which are routed—as illustrated by flow line 122, to cloud storage 112. Optional approval processes 124 may include sharing information or files with another client or outside contact through a system-generated email. Edits or revisions made to work orders can loop the work flow 126 as required. Relevant files can be downloaded 128 and finished work orders 132 subsequently become archived in cloud storage 112 and can be recalled as templates 130 for future work orders.

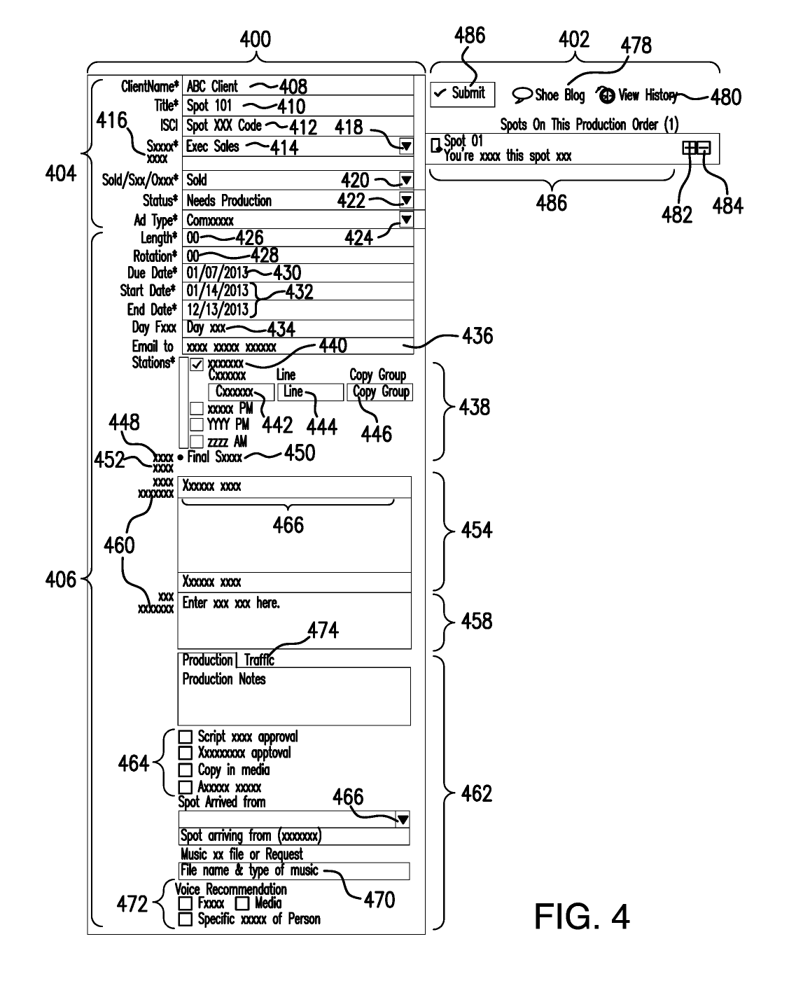

In more detail, still referring to the invention as depicted in FIG. 1, it is shown that a user submitting or accessing a work order first accesses their work orders (or work orders to which they have access based on role) through a web browser 100 to access the internet-based platform of the present invention. The user then creates and submits the work order 110, using the work order creation screen, referenced as 400 in FIG. 4, and submits the work order to the internet-based back-end, where it is verified and either accepted (placing it in the workflow as active) or rejected (requiring the user to make necessary corrections or provide mandatory fields before re-submission, where this accept/reject process repeats). The work order and promotion request form comprise a workflow model which is customized to the preferences, needs, and industry standards/regulations of the user's group or company (as well as role). Upon submitting a work order 110, the information enters the workflow—and any attached reference materials or files—are transferred via global computer network (the internet) to cloud storage 112 where a POC 114 (or other role-enabled user) can view it instantly in the workflow.

As used herein, the initials “POC” shall denote those users defined in the system as connected to the specific submitting user as part of the work order's intended workflow roles or assignments inside the group or company using the invention. If action is required by one or more of the other POCs to advance the work order within the workflow, an automatic email notification 116 is broadcast to make the user(s) aware of the requested or required action or task. These email notifications 116 occur many times at specific points of the workflow to keep each POC current and up-to-date as to the overall status and needs of a specific work order.

The POCs may begin their own specific sub-workflows 118 independently from one another. One step in a relevant user's workflow may itself contain sub-processes 120 that are handled separately from the invention, but may still be recorded in the form of audit logs or noted upon as part of the information tracked through the sub-workflow 118 of which the sub-process 120 is a part. Updates to saved information or new files are saved continuously and progressively to cloud storage 122 to ensure that the data is kept up-to-date and real-time for all users to whom the work order, sub-processes, and/or sub-workflows apply.

Some workflows may also require a review and/or approval process 124 in order for the work order to progress to the next step in the workflow. Work done to a certain milestone in the workflow can be reviewed by a relevant POC 114 or shared directly with the client (or outside contact) through a system-generated email, provided a valid, external email address is supplied. Changes or revisions to a work order can then re-insert 126 into the relevant sub-workflow 118 as required. Throughout the workflow, any and all attached reference materials can be saved locally 128 for use on the POC's computer system, independent of the browser interface utilized and the status of internet connectivity. In this manner, loss of internet connectivity ensures that the local storage of information serves as a local backup of said files and reference materials to ensure that no work is lost due to unreliable or an internet connection that is temporarily out of service.

Once each of the connected POCs' independent workflows and goals for the work order have been achieved, the work order may be processed and denoted by the system as completed. Completed work orders 132 are archived in cloud storage 112 in perpetuity, where they can be referenced, searched for, recalled, and re-used as templates 130 for future work orders.

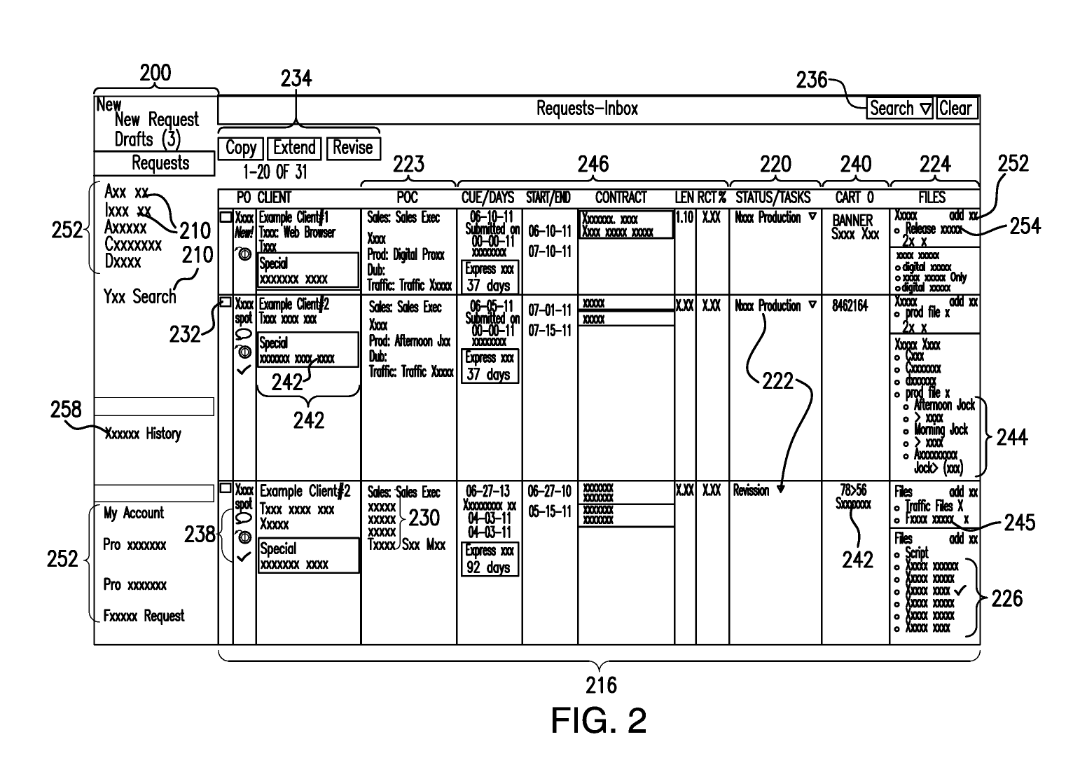

Once a user is authenticated via web browser 100, credentials and other variables are stored in a separate cloud storage database 112 to ensure security and authenticity of data transmission via the hyper-text transfer protocol standard (“HTTP” or “HTTPS”). The authenticated user is presented to his or her inbox as illustrated in FIG. 2. When users enter data into a work order 110 (also illustrated in FIG. 4), it is collected via W3C standard HTML form fields. This data, in turn, is submitted via the “POST” verb (or “mode”) of the HTTPS protocol, where it is stored on a server-side database. A submitted work order enters cloud storage 112 with all binary and ASCII client-supplied files being uploaded via “POST” of the HTTPS protocol and stored for later access on a network-accessed file system: namely, cloud storage 112—accessibly immediately via internet.

As other points of contact interact with the platform 114 via their respective accounts 100, they have unique, role-dependent points of view of the relevant work orders stored in cloud storage 112. Email notifications 116 are triggered when new work orders are successfully submitted or other defined events occur, such as sub-workflow steps 118 or work order completion 132. The email notifications to relevant points of contact are sent through a third-party email relay provider for final delivery to the point(s) of contact's email inbox, provided the email address specific to each POC is valid, verified, and matches their established user settings (commonly referred to as a “profile” or “preferences”). When any sub-workflow 118 or approval process 124 alters or updates the work order 122, the information is submitted again via “POST” of the HTTPS protocol, storing data to the server-side database where said updates can then be retrieved and viewed immediately 114. Work orders stored in cloud storage 112 can be re-used 130 by duplicating the saved data, in effect repurposing it as a new work order, leaving the previous data intact. This allows the new work order to be independent of the original, from which it was copied.

Referring now to FIG. 2, one example of the customizable layout of a user's folder/inbox using a list view is depicted. This is comprised of the left-hand navigation panel 200 that displays request counts 210 for each list view 212 filtering option (which could be thought of as a “folder”). Below, the list view 212 filtering options are “Talent Search” 214, “Recent History” 216, and basic maintenance sections 252. The columns 218 of this view vary depending on the industry using the platform, but typically display the industry standards of a client identifier and a unique title for the work order, followed by the work order's POCs 228, industry-specific scheduling and tracking details 246, the workflow status 222 in column 220, internal tracking identifiers such as Cart ID 240, scheduling status 242, as well as attached files 224.

The files section 224 allows attachment of new files 252 and recall of already-attached files 254. Notes and miscellaneous items related to the work order 226 are displayed here as well. Voice parts 244, which are simply a voice talent recording the written script for a specific work order, or any attached audio file is accompanied by playback controls 246 for instant playback via streaming. Existing work orders may be selected via check box 232, then copied, extended, or revised by clicking the appropriate boxes 234. Each element of a work order also has communication and accountability tools 238 to keep POCs 228 informed. Locating orders in any list view 212 can be expedited by running a search 236 using a customary search interface. Finally, role specific details or special instruction(s) 248 are highlighted, but can be collapsed or expanded 250.

In more detail, still referring to the invention, in FIG. 2, it is shown how a typical user views already-submitted work orders in a list mode or view. Listings other than the Inbox (which represent and collate all active work orders) are linked in a left-hand navigation panel 200 which features a tally/count 210, representing the number of work orders related to that folder or filter view 212. Filter views 212 exist to display work orders into sub-categories which exist as preset defaults, but are also user-configurable through the maintenance sections 252. The “Talent Search” function 214 allows the user to explore the available talent linked to them through the platform's network of connected groups or companies. “Recent History” 216 displays a listing of all actions logged and recorded in the system recently, in relation to the work orders with which the current user can view or is otherwise associated. The columns 218 of the Inbox and other filter views 212 display work orders separated into columns relevant to the user's workflow and industry standard, logical groupings. These columns 218 represent a simplified view of the submitted details of the work order, FIG. 4. The columns vary depending on the industry of the group or company using the invention, but typically display the industry standards of a client identifier and a unique title for the work order.

The “Status/Tasks” column 220 defines the current progression of the work order in the workflow as a whole, by status 222, or what the next step in the workflow is. The status 222 of a work order can either be manually adjusted by the appropriate POCs 228 or automatically—based on system and programmatic rules, which can reference shared tracking or identification fields such as “Cart ID” 240. The “Files” column 224 holds and displays any existing, uploaded files associated with the work order. In this area, they may also be downloaded for use on a local machine or simply streamed for quick reference. The “Files” column 224 also lets a POC select the “add file” link 252 to upload additional files and provide a label or category 254 for them. These files may be additions to previously-provided information, or as a result of a POC's workflow progression for an individual work order.

Non-file details like plain-text scripts or notes 226 are also displayed or linked to in the “Files” column 224. The “POC” column 228 displays the names of users who are defined as being part of each work order's workflow, determined by the settings of the group or company using the invention. In short, the “POC” column 228 displays which responsibilities or tasks have been delegated/assigned to whom. These delegations can happen manually as shown in FIG. 4, or according to predefined rules, referencing certain details and rules of a submitted work order or workflow to dictate to whom work is delegated.

The tasks 230 and POC 228 assignments vary depending on the media or medium for which the invention is being utilized. A work order which is already submitted may be altered or used as a template through the use of a simple check-box 232, selecting one or more work orders, and then using the “Copy”, “Extend”, or “Revise” buttons 234 pertaining to the process required. Using the “Copy”, “Extend”, or “Revise” buttons 234 then, in turn, focuses the user's attention only on the selected work orders. This requires specific fields of data to be updated based on which process is being followed. For example, any work orders selected via means of check-box 232 then the button “Extend” 234 will require that the end date as displayed in the “Due/Days” column 246 to be set at least one day later than before the “Extend” button 234 was utilized.

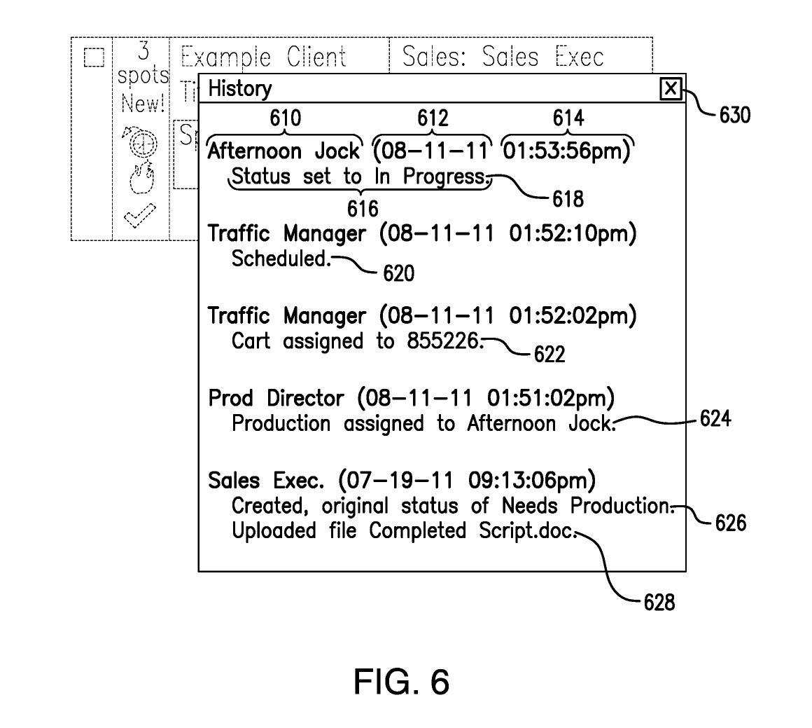

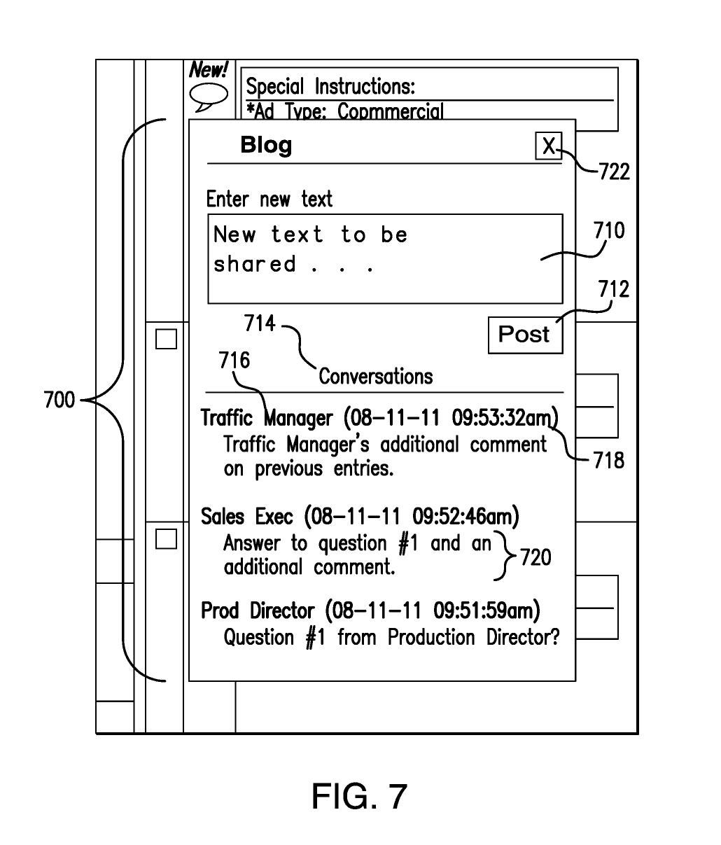

A column of assorted tool icons 238 represents quick access to displays like the blog illustrated in FIG. 7, and a history illustrated in FIG. 6 of POC 228 actions or required steps. Clicking a tool icon 238, illustrated in FIGS. 6 and 7, displays the tool or feature on top of the existing screen content for quick access (commonly referred to as a “pop-over”). Workflows that require tracking identification numbers like a “Cart ID” 240 also rely on the states of sub-workflows like scheduling 242, which shows as a toggle check-box when viewed by the POC 228 responsible for that task's sharing or completion. Sub-workflows that require and end result in the form of a new file, such as a voice part 244 being uploaded to the work order, are listed in the “Files” column 224.

Standard, industry-specific fields 246 of information are grouped and displayed for quick viewing and understanding. These fields 246 vary depending on the implementation of the invention and/or the needs or preferences of the individual POC 228. Relevant POCs 228 may view special instructions 248. These special instructions 248 are submitted as part of the original work order entering the workflow. The special instructions 248 may also be hidden as a default or expanded 250 by mouse click at the user's discretion.

The construction details of the inbox or list view are described below with reference to FIG. 2. A user's “Inbox” and other list/folder views 212 display relevant work orders based on his or her role as well as settings of the user, company, or group. The counts 210 for the various folder views 212 are generated by a query to the central database. The aforementioned query is derived from the cloud storage 112 database, ephemeral data about the user (often referred to as “session” data, which is tracked by a technology known colloquially as a “cookie”), and parameters relevant to the current folder, user, and role. The conditions which dictate the resulting count sum are provided by a narrow set of factors. These factors are: if the person is a POC 228, their relationship to the company or group from which the work order originated is valid, work orders for which the user is the originator (original submitter), or if the user is directly assigned as a POC 228 on work orders that belong to a specific folder 212.

Counts 210 indicate the total number of items in a categorized result set. The folder views 212 with which a user may filter work orders though display subsets of work orders is based on information fields inside the work order and by action taken by the user to sort or further filter the list by clicking on any column header 218. A subsequent click on the same column header 218 simply reverses the sorting order.

To generate a specific list view, a database query is generated based on these fields to display ordered information based on the conditions requested by the folder view 212. As a work order is processed by the relevant or assigned points of contact, the recent history 216 is amended, with the most recent entries appearing at the top of the list. The history feature, illustrated in FIG. 6, uses these tracked elements, while the recent history 216 link presents a list with all recorded actions relevant to the current user. The inbox and other filter/folder views 212 display in columns 218, which are sorted by two different means. First, a user-defined setting of the default column by which to sort (typically “Due Date” or “Start Date” 246). Second, a user may click the column titles to alternately sort by that column as mentioned above.

When the status 220 of a work order is advanced or changed in any way, the user may click the status drop down menu 222. The programming language JavaScript; and, more specifically, the AJAX dynamic language is used to provide quick query access to the server to set the desired status. Because AJAX is used, this process happens transparently to the user—effective immediately, but also asynchronously, as not to interrupt the user's interaction with the invention. While clicking the status drop down 222, a “GET” request via HTTPS is sent to the server to relay the data as it exists at the time of the click. This, in turn, returns a list of available status options (based on the condition, status, and other details of the work order) which the invention translates into a graphical list representation of these available statuses. Clicking any of the displayed status options uses the same principles of an AJAX “GET” request to ensure the work order is updated with the selected status.

For the user effecting a status change, this will also occasion the entire row for the specified work order to change color. (Each status has a pre-defined background color that, because it's easily to individuate, makes it more efficient for a user to locate work orders that presently have a particular status.) Similarly, for all other users who may see the selected work order, the action of changing a status will cause the status name 220 and the work order row's background color to change, as to reflect the most current information about said work order.

Further queries for status 222 on a worker order will return a (potentially) new list of status options.

At the workflow point of submitting (or during the workflow of a work order), files may be attached. In the Files column 224, a prompt in the manifestation of a pop-over form is displayed when clicked. This form, referring only to the work order from which the add file 252 link is clicked, permits the user to select the file to be uploaded, specify a category or label 254, and allow the data to be transmitted over a “POST” request via the HTTPS protocol. When standard, widely-supported audio files are uploaded (such as MP3 or WAV) in the files column 224, playback and download controls 246 are displayed. The audio is progressively streamed over the HTTPS protocol, which plays the binary audio file via the browser as data is transferred incrementally. This means the user does not have to download the entire file before it can be played back.

Additional notes in the files column 226 can be displayed with a mouse click. Pop-over content is displayed, similar to a status change 222. The content in this pop-over is assembled using AJAX, which requests relevant data: notes, file lists, or a form to submit new data. A user who wishes to use an existing work order as a starting point for a new or similar work order (or who needs to update an existing work order) may use the spot check box 232 to select one or more items to then be copied, extended, or revised via their respective buttons 234.

The “Copy” function duplicates saved data as a new work order, leaving the previous/ancestor work order intact and allows the new work order to be completed with total independence with regard to the work order from which it was copied.

“Extend” and “Revise” are technically similar insofar as how the data changes within the database. While “Extend” copies the work order and requires the user to just supply one new field (“End Date” 246), “Revise” requires the work already completed to be redone or modified according to the modification instructions given in notes 226, special instructions 248, or the blog tool 238. “Revise” also requires more complete instructions on how the work order should be modified to justify other points of contact to begin to execute those changes.

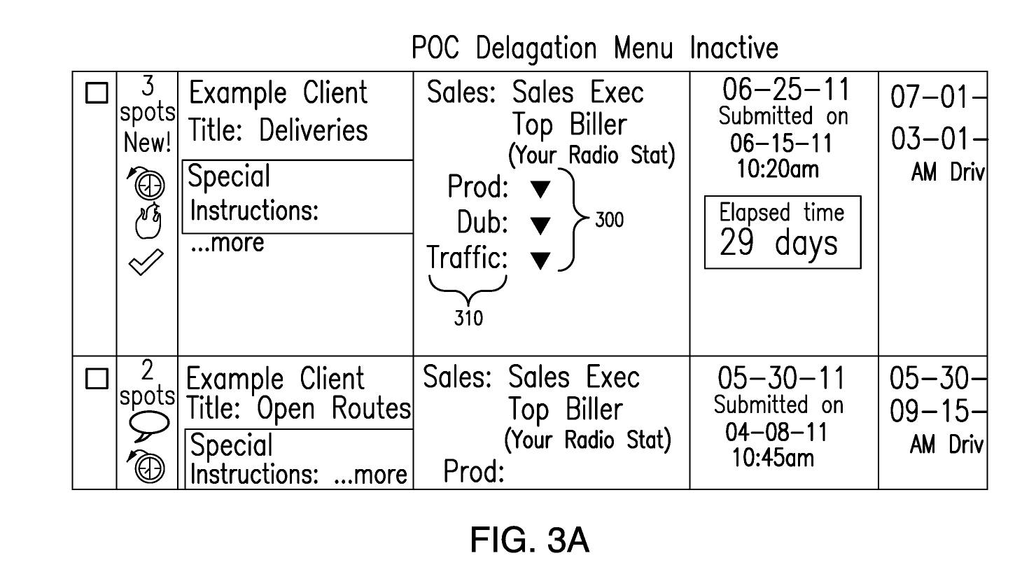

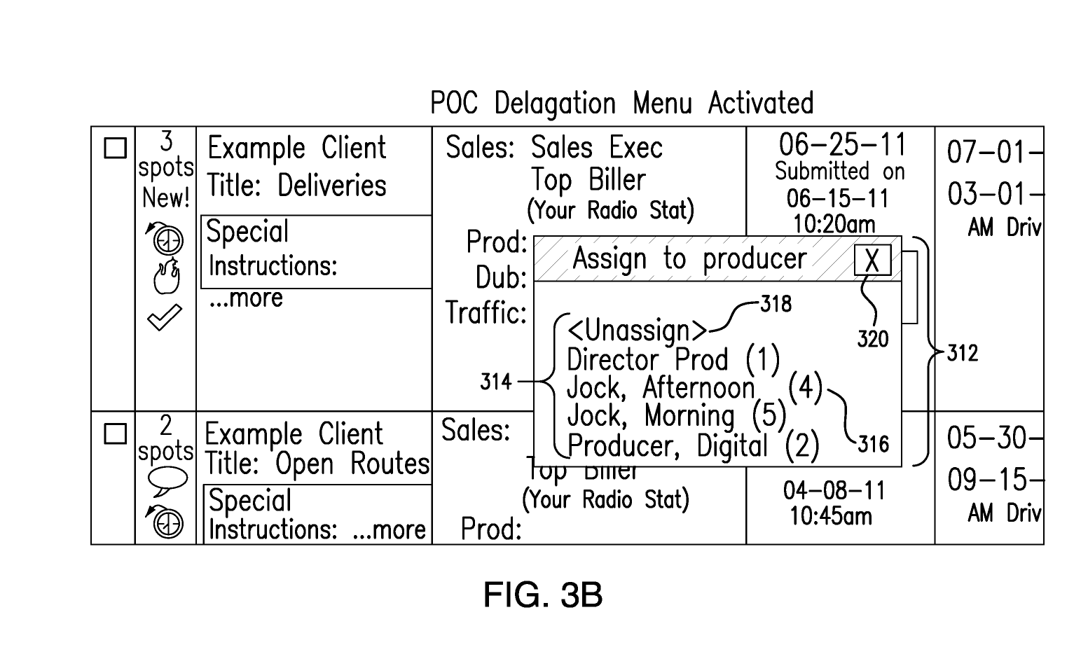

FIG. 3 illustrates how the user may delegate and effectively assign tasks using drop-down menus 300 for a given work order. The delegation drop down 312 shows the user all other relevant POC candidates 314 responsible for that specific task 310, as well as a workload count 316 to assist in allocating workloads and assignments evenly. Delegations may be unassigned 318 or closed 320 as well. Designated users on the platform may assign tasks to other POCs with delegation drop-down menu 300 accessible from the POC column, referenced 228 in FIG. 2. The menu is available only to specific POCs as defined in system settings and role-based permissions.

The tasks 310 vary, largely dependent and adapted for the industry using the platform. A mouse click will activate the drop-down 312 and list POCs 314 who are available for task assignment. This drop-down 312 list also displays the workload count 316 of each POC 314, specific to the task 310. The POCs 314 displayed may be physically located at the same group or company as the user assigning tasks; they could easily be at any external location linked to the user through predetermined links within the invention.

Clicking the mouse on a listed POC 312 for the task 310 assigns it to that POC 312 who then receives an automatic email notification that this new task 310 has been assigned via the invention. Only when a task 310 has been assigned to a specific POC 312 will that POC have access to the work order from their account's view as outlined in FIG. 2. If a POC 312 already has been assigned to a task 310, they can be unassigned 318 as well. If no delegation is needed for a task on a relevant work order, the user may close 320 the drop-down menu 312.

The construction details of the POC delegation menu is described below with references to FIG. 3. Clicking on the delegation drop-down menu arrow 300 or task name 310 for a specific work order performs an AJAX call via “GET” over HTTPS to retrieve the list of relevant points of contact the user may select. The list of POCs in the list is dependent upon the duties assigned to a user or POC as defined in their user settings (by the user or an administrator). A result set from the database is retrieved via AJAX over HTTPS and presented to the user as a list of names. These relevant points of contact 314 also include associated counts 316 to indicate their current workload, limited and specific to the task being assigned or delegated. Counts are calculated by the number of work orders each POC has been specifically assigned for the type of task. A global index is used to pair the given names of the POCs to unique identifiers (numerical) in the database, the type of task they are assigned, and the work order with which it is associated. Selecting a name will set that task 310 to be that POC's responsibility immediately. At this time, an automatic email notification is sent to the POC.

If a POC contact 314 is no longer required to be assigned to a specific task 310 on a work order, the user may select “Unassign” 318, which will unset the task 310 from that point of contact's listing 310 of delegated or assigned work orders. The delegation drop-down menu 312 may also be closed by clicking the button 320 if no further actions are required by the user.

FIG. 4 depicts a screen display for a typical work order for initial data entry, divided into a left side 400 and right side 402 column. Fields recorded include the constant fields 404 of; client (or advertiser) name 408, work order (spot) title 410, an intentional standardization commercial identifier (ISCI) code 412, a sales POC 414, sold state 420, initial workflow status 422, and a specific ad type 424 (typically hierarchical and categorical).

Once the constant fields 404 are provided, their values, specifically those of sold 420, status 422, and ad type 424, determine which variable fields 406 are shown subsequently. These variable fields 406 differ depending on what industry is using the invention. Customary variables include the industry standard fields and information required for creation of work for audio, video, web display, or print. Commonly used fields include, but are not limited to: length 426, rotation percentage 428, due date 430, run dates 432, and day part 434 (time of day).

Work orders may also capture a client email address 436, one or more stations 438 for broadcast, and files 448 relevant to the work order. In lieu of attached computer files 448, raw text can be provided in script 454 or tag 458 form. Complete orders are submitted with the “Submit” button 476. Communication and tracking tools like the blog 478 and history 480 for the work order may be displayed in the right side column 402. Multiple requests may also be added 482 or removed 484 from the work order. (Work orders may contain one or more requests, though these requests are almost always related . . . typically all belonging to the same advertiser or client 408.)

Spot details 486 synopsize key information from the right side column 402 for visual navigation when multiple requests are added to a work order.

As illustrated by FIG. 4, the work order is divided into a left column 400 and a right column 402. The constant fields 404 are provided first. The values assigned to these directly dictate which subsequent, relevant fields 406 are shown to the user. Fields being recorded first in the left column 400 include the client name 408, which is the advertiser requiring the work to be completed on their behalf. More specific identifiers for the resulting work order are given as a spot title 410, and/or an ISCI code 412. Fields included, but not limited to, the title 410 and ISCI 412 can be set as required fields in the system's settings. They may also be hidden if not used by the client or industry.

Next, the user in process of completing the work order is, by default listing, the account executive 414 and displayed as the sales POC in the inbox or list view's POC column 228 in FIG. 2. When multiple account executives 414 are responsible for a work order, they may be added with the add person link 416. Should someone other than the desired account executive be completing the work order, the drop-down menu 418 may be clicked to change the sole name being associated. The sold/spec/other selector 420 is set to sold by default. Spec and other alter which required fields must be provided before the work order can be successfully submitted and enter the workflow. The status 422 of a work order defines its attentive need in the overall workflow. The status 422 field permits the submitting user to set the starting point from which it may be altered by means of scheduling or interaction with creative staff. This is similar to the status drop-down 222 as illustrated in FIG. 2.

Available status options in the status 422 drop-down vary depending on the industry of use with the invention. The ad type 424 pinpoints the category of the request as defined by the users of the invention. The combined input of the status 422 and ad type 424 reveals or hides the variable fields 406. These variable fields 406 are customized depending on the industry of use with the invention.

They may include length 426, which details the length of time of the final work in seconds (when it pertains to an audio or video file). Rotation 428 is a percentage specifying the frequency of the final work's appearance or broadcast should it share run dates 432 with other spot titles 410 for the same client 408 on the work order. Due date 430 is the date by which the requester needs the work order's final work completed. The run dates 432 detail the date range the final work will be broadcast or displayed. Day part 434 signifies a time frame during each day of the run dates 432 that the final work will be broadcast or displayed. The email-to field 436 is used to collect any email addresses to which the final work should be delivered when the work order is complete (or as part of a requested approval phase 464, should the option be requested.)

The stations section 438 allows the submitter to pinpoint the broadcast channels, digital mediums, web sites, or other mediums. A selected station's checkbox 440 can also reveal further industry-specific tracking information such as contract 442, line 444, or copy group 446.

The files section 448 is where the submitter may attach a computer file through a standard upload dialog. Previously attached files are shown with an “X” icon 450 alongside the filename so that they may be deleted from the work order. Multiple files may be attached by clicking add file 452.

The script area 454 allows submitters to type or copy-and-paste text that will be included in their work order. The script box 454 includes basic rich-text formatting options 456, permitting the user to add formatting elements (such as bold, color, italics, etc.) to the script.

The tag area 458 allows for text to be entered which might be shorter or less complex than the full script 454.

Both script 454 and tag 458 text areas have an estimated length counter 460, which is calculated based on a ratio of 90 written words per 30 seconds spoken.

The notes and option section 462 is shown for providing additional instructions and setting industry-specific options. These options are customized depending on the industry of use with the invention. Shown in FIG. 4 are audio-specific production options which are mostly used in terrestrial radio broadcasts.

Checkboxes 464 for script requires approval, spot requires approval, copy to media, and aircheck required will create information elements included in the special instructions 248 in FIG. 2, and additional notes sections 226 in list views as illustrated also in FIG. 2.

Spot arriving from 466 is one industry-specific drop-down menu that may be customized. In FIG. 4, spot arriving from 466 references outside locations from which audio or video files are retrieved. Sources not listed in the drop-down 466 may also be listed manually via free text in the “other method” field 468. Text may also be supplied to suggest or outline music styles used through the music bed file or request field 470.

Voice recommendation checkboxes 472 also allow the submitter to suggest which type of voice the final work should include.

The details under notes and options 462 can be further divided into groups through departmental tabs 474. Depending on the industry in which the work order is being utilized, these tabs 474 can be customized for the end-user to show text that conforms to their preferred or standard fields as needed.

The right column 402 features tools and navigational items. The submit button 476 will finalize the work order and present it to other staff in the workflow. Prior to clicking the submit button 476, each change on the work order is saved incrementally as a draft that can be accessed from a folder in the navigation panel 200 of FIG. 2. Show blog 472 will present drop-down access to the communication tool shown in FIG. 7. View history 480 allows the user to see the history of actions taken on this work order, as shown in FIG. 6. The Plus (+) 482 and Minus (−) 484 buttons add and remove single entry requests from the overall work order. Plus 482 will copy the bulk of fields provided in the on-screen request and present them as a template for the additional request on the same work order. Minus 484 simple removes the corresponding request from the overall work order.

The spot details list 486 in the right column 402 highlights informational points about the presently open request on the work order. The spot details 486 help differentiate one request on the work order from others by showing the title 410 and other useful points of information as they are provided.

The construction details of the work order submission interface are described below with references to FIG. 4. The information collected when a work order is entered or edited is saved incrementally to the database as it is typed by the user. Said information is transmitted to the database by means of a “POST” HTTPS request. Date fields such as run dates 432 and due date 430 provide the user with a visual calendar pop-out control. This enables the user to navigate through a calendar and click the desired date instead of having to type it manually.

The text entered as script 454 or tag 458 displays a length estimate. This is done by passing the contents of each field to the server, where it is parsed and the calculations performed. Subsequently, using AJAX, the on screen value 460 is updated with each key press. The resulting value, when not a whole number, is rounded to one decimal place.

Navigation away from the work order in the web browser does not affect the integrity of the data that has been entered up to that point. As mentioned previously, this is because the user input is saved as it is entered . . . in an incremental fashion using AJAX and HTTPS requests which, in turn, relay the input for storage in the database.

During submission from clicking submit 476, all data are processed by a separate server-side programmatic script which handles the “POST” request via HTTPS. Each field is verified, required fields are checked for omissions, and the submission is either successful (and the user returns to a list view)—or it fails, and the work order highlights what the user did incorrectly or omitted and instructs them on how to correct it. Until a work order is successfully submitted, only the creator may see or edit it.

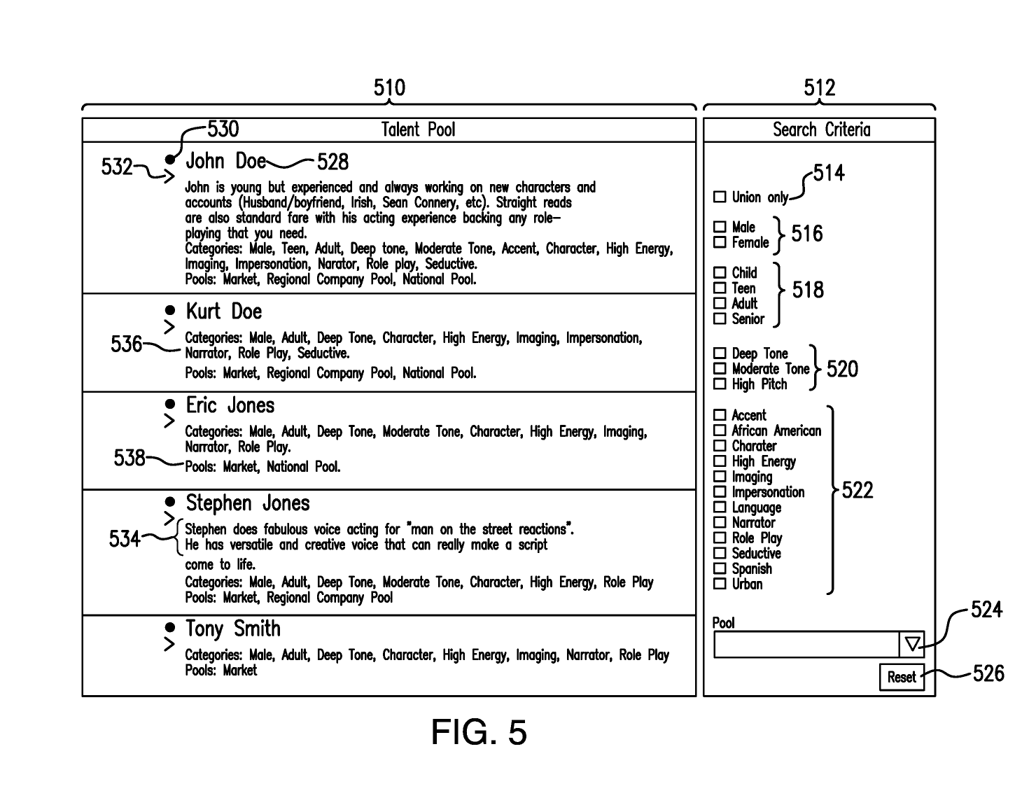

Turning now to FIG. 5, the talent search tool is disclosed. The talent pool area 510 lists details about available talent according to those who match the search criteria 512 as selected in that list. These industry-standard voice properties are included, but not limited to: union only 514, gender 516, age 518, tone or pitch 520, and other voice traits and qualities 522. The pool drop-down 524 may select a specific voice pool (group) and the reset button 526 will clear all checked search criteria 512. The talent pool section 510 shows the names of the talent 528, the talent's availability 530, an audio sample with streaming playback controls 532, a personalized description by the talent 534, matching categories 536, and the voice pools 538 in which the talent is listed.

With continued reference to FIG. 5, users may explore the voice talent available to them. Talent search can be accessed from the talent search link 214 in FIG. 2. The talent pool area 510 lists details about available talent. The search criteria 512 allows the user to specify categories of voices to be selectively displayed in the talent pool area 510. Inside the search criteria section 512, a user may check specific types of voices using industry-standard qualities. These search selections are cumulative. Union only 514 may be selected, should the user be concerned with the union status of a particular voice talent.

The gender 516, age 518, tone or pitch 520, and other standard voice traits 522 may be selected at the user's discretion. As the various search options are selected and deselected 512, the listing of matching voice talent in the talent pool area 510 will update in real-time. The pool drop-down 524 is used to limit the displayed voice talents by defined groupings of voices such as local, regional, or national associations (or ad-hoc voice pools/groups).

Voice pools may be established and managed by the group or company using the invention.

Upon clicking the reset button 526, all search criteria 512 are cleared. Voice talents listed in the talent pool section 510 will display details about the person and his or her abilities as saved in individual account settings or profiles. The talent's name 528 is listed along with a color-coded availability icon 530 that will be green if the user is available—and red if the user is not available. Each voice talent provides an audio sample that can be streamed instantly with the play button 532 below each talent name 528. The full list of each talent's categories 536 or search criteria 512 are listed as well, followed by the specific pools of voices 538 to which they are connected within the invention.

The talent pool search criteria 512 are industry-standard qualifiers for an individual who would perform the task of voicing (recording via microphone for later production) a script or tag. When an item is selected in the search criteria area 512, this event triggers an AJAX request to the server via HTTPS (with the selections), which returns a list of results that match the selections. In the talent pool area 510, a user can review the results of the search criteria 512. The availability icon 530 changes depending on the talent's status and availability.

Turning now to FIG. 6, the tracking of workflow in the history drop-down 600 is disclosed. Specifically, each POC's name 610, action(s) 616, date 612, and time 614 that the action(s) 616 occurred are available. Actions being logged may include but are not limited to: status changes 618, scheduling and dubbing confirmations 620, Cart ID assignments 622, task delegations or assignments 624, initial or starting status 626, or files being attached 628. The history pop-over 600 can be closed by clicking the “X” icon 630.

With continued reference to FIG. 6, it is shown that a pop-over display shows relevant, past actions specific to an individual request/spot, its parent work order, and the overall workflow. The interacting POC's name 610 is state in a given then surname format. Following the POC's name 610, the date 612 and time 614 of the action are displayed parenthetically. The time 614 is adjusted and specific to the time zone of that POC's 610 group or company. The second line of the individual history entry displays the recorded action 616. Further, this second line is given as succinctly as possible, as demonstrated by the second entry, “Scheduled” 620. When two actions occur simultaneously by the same POC, they are concatenated into one entry, with each action residing on its own line (626, 628).

The list view, as seen in FIG. 2, has a set of icons 238, including one for viewing a work order's history. When the icon representing history is clicked, a server request is made with the identifying work order as a parameter. The history (or list of user actions up to that point) is returned and formatted graphically as depicted in FIG. 6. For each time a user's action is carried out in the invention, a database entry is created which logs who 610, what 616, and when. This information is appended to an ongoing audit trail (or central log) with which no user may tamper. This history list may later be viewed using the work order's auto-generated unique identifying number (or key).

Turning now to FIG. 7, it is shown how the blog 700 takes in new text 710 to post 712 to the conversation 714 for a specific work order. Each post 712 is displayed with the submitting user's name 716, a date and time 718, and the text 720 entered by the users. The close button 722 will hide the blog 700 from the user. Each new post 712 sends an email notification with the full conversation 714 to all relevant POCs.

FIG. 7 further shows how the blog 700, accessed from within a list view, referenced as 238 in FIG. 2, may be used to add details or to converse about a specific work order. FIG. 7 further reveals a blog and conversation typical to a commercial radio workflow. A user may enter questions, comments, answer previous interrogatives, or add any new information they wish to share by typing it into the new text field 710 on the blog 700 drop-down. When the user clicks post 712, the text entered 710 will be saved as part of the conversation for the specific work order. Clicking post 712 also triggers an automatic email to the relevant POCs 228 as illustrated in FIG. 2 to alert them that new information has been added to the ongoing conversation 714. The blog 700 also displays the previous entries to the conversation 714 in chronological order beginning with the most recent entries at the top 716.

The construction details of the blog drop-down are described below with references to FIG. 7. The list view, seen in FIG. 2, has a set of icons 238, including one for viewing a work order's blog. Clicking icon 238, representing blog, activates a data transmission to the server which retrieves and sorts the blog conversation 714 for a particular work order, presenting it in graphical form to the user as seen in the blog 700. Text is entered in the new text field 710; and, when the post 712 button is clicked, a data transmission is sent to the server using a “POST” request using the supplied parameters (text, user details, action, time/date, etc.). These details are immediately written into the database. Each time new text 710 is posted 712 to the blog 700, an automatic email notification is sent to the relevant POC, illustrated in columns 228 of FIG. 2. The relevant POC data is stored in the database, which represents the person, duty or task assigned, and the work order for which it is associated. This list is used to identify the POC and retrieve email addresses stored within the database. Emails are then sent by way of an email relay provider for final delivery to the POC's inbox.

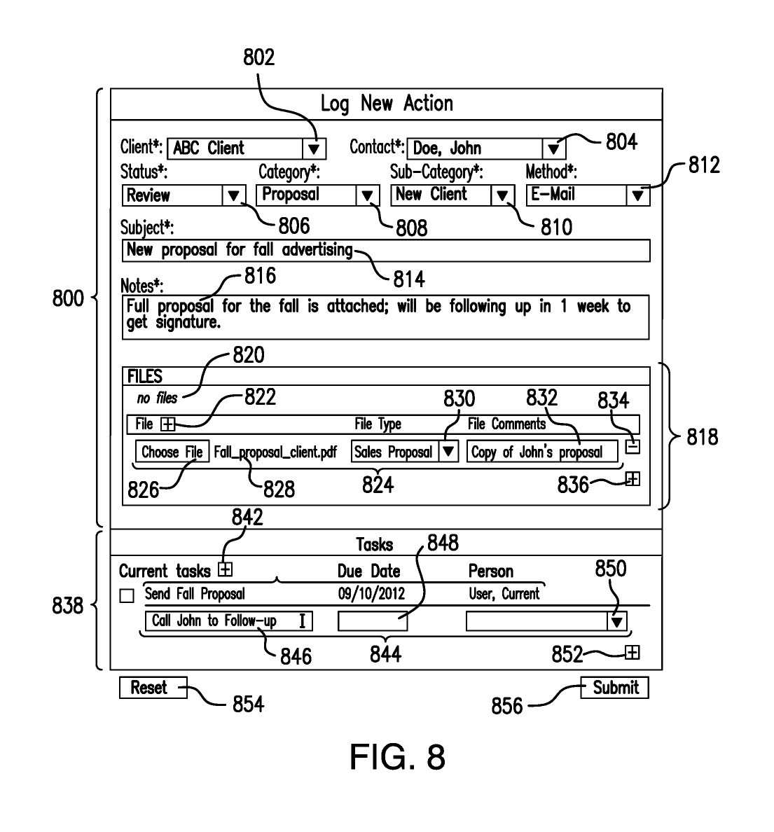

Turning now to FIG. 8, it is shown how users may log customer relationship management (CRM) actions. The log new action section 800 begins with the client field 802 and a contact field 804. Status 806, category 808, sub-category 810, and method 812 are drop-down selections for detailing the action with group or company defined fields. A simple subject 814 for the action logged is followed by more descriptive notes 816. The files section 818 lists any already-attached files or a notation of“no files” 820 and the plus sign 822 to add a new file attachment line 824.

After locating a file via the choose file button 826, the file's name 828 is shown, and the user may then set the file type 830 and add any relevant comments 832. The minus sign button 834 will trim unneeded or unwanted file attachment lines 824, and a secondary plus sign 836 is provided for convenience. The tasks section 838 shows current tasks 840 and a task specific plus sign button 842 for adding new task lines 844, which has a task description 846, due date 848, and the person 850 assigned to the task. A secondary task specific plus sign button 852 is provided for convenience. The reset button 854 will clear all entered information, while the submit button 856 saves the information.

FIG. 8 further discloses that users may log customer relationship management actions. In the log new action 800 section, the client field 802 is set with a drop down, populated by the clients associated with the user presently using the invention. The contact 804 drop down populates with the names of existing contacts associated with the client 802 presently selected. Status 806 details the placement of this logged CRM action in the group or company specific workflow. The status 806 options available to the user are set by their group or company to reflect the specific needs of both. Category 808 details what type of CRM action is logged.

Sub-category 810 gives the user an additional level of detail beneath the already given category 808. The options available are dependent on the parent category 808 as set first. The sub-category 810 options available to the user are set by their group or company to reflect specific needs. Method 812 details the medium of communication being used for this CRM action. These methods 812 may be internal or external in nature.

Subject 814 is a short descriptor of the new CRIM action being logged. The subject 814 is shorter and less detailed than the notes 816. When notes 816 are entered, they are provided for a more detailed explanation of the CRM action that is logged.

The tasks section 838 allows the user to view current tasks 840, as well as add new tasks with the task specific plus sign button 842. The task line 844 consists of the tasks description 846, a due date 848, and the person 850 being assigned the task. The person drop down 850 gives the user the option to select themselves or another POC at their group or company to be responsible for completing the task 846 before the due date 848.

When any user or POC is assigned a task, an automatic email notification is sent to them with a synopsis of the tasks 838 section. A secondary, task-specific plus sign 852 is provided for convenience at the bottom right of the tasks section 838. Finally, there are reset 854 and submit 856 buttons at the bottom. Reset 854 will clear any information entered, while submit 856 will save the information.

When the user clicks the client 802, contact 804, status 806, category 808, sub-category 810, method 812, file type 830, or person 850 drop-downs, a request via HTTPS is sent to the server to collect the data to populate the drop-down, presenting the user choices in the list.

Files 828 included upon submitting 856 the form may be attached with the choose file 826 button. This, too, employs standard form fields. When the user clicks the submit button 856, the locally-stored files are uploaded using a “POST” request. When a new CRM action is logged, the information is collected by standard HTML form fields. When the user clicks submit 856, a “POST” request is sent to the server (including the form fields), and the data is written to the database immediately. In summary, when a user clicks submit 856, the data (including any file attachments) are stored in the database and cloud-based storage (112, FIG. 1).

What is claimed is:

1. A database-powered, programmatic application embodied on a computer-readable medium for execution and use on a computer in conjunction with an internet-based application that provides a workflow management platform for creating, producing, and scheduling a commercial advertisement from any location over a global computer network, comprising:
a. A work order generation interface that receives information relating to the creation of a commercial advertisement, thereby creating a work order,
b. An inbox and folder interface that displays information relating to work orders;
c. A search and sort interface that provides the ability to further filter and sort the results of a folder to efficiently and accurately locate work order(s) required by a user;
d. A talent search interfaces that provides intuitive, rapid search functionality to locate available and suitable talent for the purposes of procuring a performance;
e. Said talent search interface is capable of filtering and searching for voice performers based on matching categories, groups, and criteria/attributes;
f. A history interface that lists past actions relating to said work order, including the name of the person, date/time, and description of action(s) taken;
g. A customer relationship management interface that allows customer interactions and relationship actions to be logged and tracked.

2. A computerized, programmatic continuity workflow management method for creating, producing, and scheduling a commercial advertisement over a global computer network, said method comprising:
a. Generating a work order for a commercial advertisement using a work order creation screen, and submitting the work order to said internet-based data storage system;
b. Providing a user interface to allow remote user points of contact (POC) with internet access to said work order via a global computer network, with each POC possessing a role to contribute in the creation, production, or scheduling or said commercial advertisement;
c. Said user interface providing an inbox and folder structure/function which displays information relating to said work order;
d. Said user interface providing a delegation menu function that allows a POC to assign tasks to other POCs;
e. Said user interface providing a talent search function that allows POCs to search for and procure available talent matching a user's matching selected criteria, said search function capable of displaying a talent pool list, which provides details and prior work examples about individual talent listings;
f. Said user interface providing an unimpeachable history ledger that displays all past action(s) relating to said work order, including the name of the POC having completed the action, date and time of the action, and a description of the action(s);
g. Said user interface providing customizable fields, approval requirements (which restrict said work order's visibility based on its disposition with regards to being approved or unapproved), and implementation and distribution of resources and assets relating to the creation, production, and scheduling of commercial advertisements;
h. Said user interface providing a customer relationship management logging function that permits customer relationships and interactions to be logged and recalled for reference;
i. Selectively transmitting email communications to individual POCs or groups, said email communications including information relevant to the status of said work order in the workflow as a whole.

3. The computerized continuity and creativity workflow management method according to claim 2, further including means for integration with separate, industry-standard systems in order to communicate and share data.

4. A computerized, internet-based continuity management system for creating, producing, and scheduling a commercial advertisement, said system comprising:
a. A software repository stored on an internet-based data storage system;
b. Said software including an interface to allow remote users with internet access to said software, each user having a role to contribute to the creation, production, or scheduling of the commercial advertisement;
c. Said interface including means for generating a work order for commercial advertisement and submission or said work order to said internet-based data storage system;
d. Said interface including an inbox and folders which display information relating to said work order;
e. Said interface including means for allowing a user to customize fields and denote approval requirements relevant to any workflow involving said work order;
f. Said interface including means for allowing a user to delegate tasks to his or her self and/or other users;
g. Said interface including means for allowing a user to search a talent database for available talent that match select search criteria, whereby a derived talent list provides details about available talent matching said criteria by means of display in a list;
h. Said interface including means for displaying past actions relating to said work order, said past actions including the name of the user having completed each action, the date and time of each action, and a description of each action;
i. Said interface including means for logging customer relationship management actions;
j. Whereby a plurality of users may contribute to the creation, production, and scheduling of commercial advertisements from remote locations.

5. The computerized, internet-based continuity management system according to claim 4, further including means for integration with other industry-standard systems to share and transfer data.

6. The computerized, internet-based continuity management system according to claim 5, wherein said interface further includes means for transmitting and receiving email communications.
